(19) United States
(12) Patent Application Publication
(10) Pub. No.: US 2001/0051889 A1
(43) Pub. Date: Dec. 13, 2001

(54) System and method for managing contract labor activities

(76) Inventor: Ralph C. Haney, Frisco, TX (US)

Correspondence Address: David G. Wille, Esq., Baker Botts L.L.P., Suite 600, 2001 Ross Avenue, Dallas, TX, 75201-2980, US

(21) Appl. No.: 09/876,477

(22) Filed: Jun. 7, 2001

Related U.S. Application Data
(60) Provisional application No. 60/210,590, filed on Jun. 8, 2000.

(51) Int. Cl. G06F 17/60

(52) U.S. Cl. 705/8

(57) ABSTRACT

Systems and methods for managing contract labor activities are disclosed. A system and method could include the capability to receive a contract labor request and disseminate information regarding the contract labor request to vendors. A system and method could also include the capability to receive and distribute resumes of candidates from vendors and generate a message containing a purchase order for the services of the selected candidate. A system and method could further include the capability to receive a compensation request associated with the purchase order and generate a message for invoicing when the compensation request is approved.

### RELATED APPLICATION

This application claims the benefit of U.S. provisional application Serial No. 60/210,590, filed Jun. 8, 2000, entitled Outsourcing System.

### TECHNICAL FIELD OF THE INVENTION

This invention relates generally to contract labor and, more specifically, to a system and method for managing contract labor activities.

### BACKGROUND OF THE INVENTION

Typically when a company needs contract labor, a variety of forms must be completed and sent between various persons in the company, such as, for example, the requesting manager, the resource manager, and the resource approver. Upon receiving approval for the contract labor, the resource manager selects, usually by using notebooks and/or personal knowledge, one or more vendors that supply contract labor and sends them an e-mail or fax describing the need. The vendors then fax resumes to the resource manager, who screens them and forwards the acceptable ones to the requesting manager. The requesting manager then screens the resumes and interviews the appealing candidates. Upon finding an appropriate candidate, the manager notifies the resource manager, who negotiates with the vendor for the candidate's services. Once the negotiations are complete, the company sends a purchase order to the vendor.

During the consultant's performance, she periodically submits time sheets to the requesting manager. The requesting manager then approves the time sheets, and they are sent to the vendor, which generates an invoice and faxes it to the company's accounting department. Upon receiving the invoice, the accounting department makes arrangements to pay the vendor and/or consultant.

Unfortunately, because of the numerous exchanges of information during the contract labor activities, it may be difficult to associate documents with the appropriate contract labor request or to even know the status of the contract labor request. For example, the requesting manager may have difficulty determining the status of the contract labor request if she cannot reach the resource manager. As another example, the resource manager may have difficulty determining which contract labor request is associated with received documents, such as resumes. As a further example, the accounting department may not know which purchase order is associated with an invoice and/or whether the expense for the invoice has been approved. As still a further example, the vendor may not know the status of candidates it has submitted or with which contract an approved time card is associated. Thus, the process of acquiring, managing, and billing for contract labor is a disjoined process, which usually results in delay and frustration.

### SUMMARY OF THE INVENTION

The present invention substantially reduces or eliminates at least some of the disadvantages and problems associated with previously developed systems and methods for managing contract labor activities. Accordingly, the present invention, provides a system and method that, at least for some parts of the system and process, have better organization and access to information regarding contract labor activities.

In particular embodiments, a system for managing contract labor activities includes a communication interface, a memory, and a processor. The communication interface is adapted to be coupled to a communication network and is operable to receive information from and send information to the communication network. The memory is coupled to the communication interface and is operable to store information received through the communication interface. The processor is coupled to the memory and is operable to receive a contract labor request, receive a list of vendors associated with the contract labor request, associate the list with the contract labor request, and generate a message containing information in the contract labor request for at least one of the vendors.

In certain embodiments, a method for managing contract labor activities includes receiving a contract labor request through a communication interface and receiving a list of vendors associated with the contract labor request through the communication interface. The method also includes associating the list with the contract labor request and generating a message containing information in the contract labor request for at least one of the vendors.

In other embodiments, a system for managing contract labor activities also includes a communication interface, a memory, and a processor. The communication interface is adapted to be coupled to a communication network and is operable to receive information from and send information to the communication network. The memory is coupled to the communication interface and is operable to store information received through the communication interface. The memory is further operable to store purchase orders for contract labor requests. The processor is coupled to the memory and is operable to receive a compensation request, associate the compensation request with a purchase order, generate a message containing information from the compensation request, receive a message indicating that the compensation request is approved, and generate a second message containing information from the compensation request.

The present invention possesses several technical features and advantages. For example, in particular embodiments, the present invention allows the different activities of the contract labor process to be centrally controlled. Thus, the forms used and information gathered may have a fairly consistent format, which allows ease of use for those using and managing the system. Additionally, individuals may access the information to determine the status of the items for which they are responsible. Moreover, the information from one person regarding a contract labor request may be readily associated with that from other persons regarding the same contract labor request. As another example, in certain embodiments, the present invention allows at least certain aspects of the contract labor process to be handled electronically. This allows the process to proceed quickly and reduces the probability of lost documents or information. Furthermore, this allows individuals to readily access the information to determine the status of the items for which they are responsible. Moreover, this allows the collection and utilization of information regarding the various aspects of the contract labor process, such as billing rates for labor and the quality and capabilities of the vendors. Furthermore, in some embodiments, the invention allows certain individuals in the contract labor process to review comments of individuals that participate later in the process. This allows the earlier participants to learn what subsequent participants expect and need and, thus, to provide better performance the next time. Other embodiments may possess none, one, some, or all of these technical features and advantages and/or additional technical features and advantages.

Other technical features and advantages will be readily apparent to one of skill in the art from the following figures, description, and claims.

### BRIEF DESCRIPTION OF THE DRAWINGS

To provide a more complete understanding of the present invention, especially when considered in light of the following written description, and to further illuminate its technical features and advantages, reference is now made to the following drawings, in which:

FIG. 1 illustrates one embodiment of a system for managing contract labor activities;

FIG. 2 shows a flow diagram for one embodiment of a contract labor activity handled by the system;

FIG. 3 shows a flow diagram for one embodiment of another contract labor activity handled by the system;

FIG. 4 illustrates a form that a requesting manager would fill out to initiate a contract labor request in the system;

FIG. 5 illustrates a form that a vendor would fill out during a contract labor activity;

FIG. 6 illustrates a form that a consultant would fill out during a contract labor activity; and

FIG. 7 illustrates one embodiment of a contracts computer for the system.

### DETAILED DESCRIPTION OF THE INVENTION

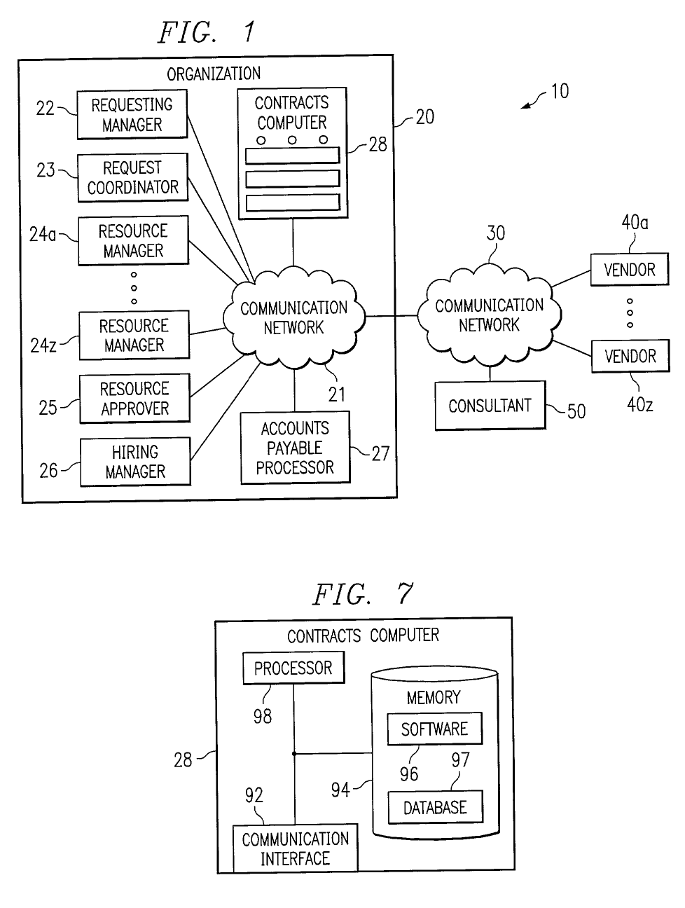

FIG. 1 illustrates one embodiment of a system 10 for managing contract labor activities. In general, system 10 includes an organization 20, a communication network 30, a variety of vendors 40a-z, and a consultant 50. Organization 20 is the entity that requires the contract labor, vendors 40a-z are entities that supply contract labor, and consultant 50 is the person performing the contract labor. Communication network 30 allows organization 20, vendors 40a-z, and consultant 50 to exchange information with each other.

In operation, organization 20 submits, through communication network 30, a contract labor request to at least some of vendors 40a-z. The selected ones of vendors 40a-z then submit, again through communication network 30, information regarding candidates for the position. Organization 20 then selects one of the candidates and sends the vendor that submitted the selected candidate a purchase order for the candidate's services. This candidate becomes consultant 50.

Consultant 50 then performs work for organization 20. At some points in time, consultant 50 submits, again through communication network 30, time sheets, which are one example of compensation requests, to organization 20. The time sheets are reviewed by organization 20 and, if correct, are approved and forwarded to the appropriate one of vendors 40a-z. The vendor then submits an invoice to organization 20, which pays the vendor and/or consultant.

In more detail, organization 20 includes a variety of individuals who participate in contract labor activities—a requesting manager 22, a request coordinator 23, a number of resource managers 24a-z, a resource approver 25, a hiring manager 26, and an accounts payable (A/P) processor 27, each of which has a computer coupled to a communication network 21 of organization 20. Organization 20 also has a contracts computer 28 to coordinate the contract labor activities.

In operation, when requesting manager 22 needs contract labor, she uses her computer to access contracts computer 28, through communication network 21. Contracts computer 28 then provides a contract labor request (CLR) form to her computer, which displays it in a graphical user interface (GUI). Requesting manager 22 may then complete the CLR form on her computer and submit it to contracts computer 28. Contracts computer 28 sends the CLR form to the computer of one of resource managers 24a-z. The selected resource manager may then review the form in a GUI and notify contracts computer 28 if any errors are detected. If the resource manager detects any errors, contracts computer has the requesting manager correct the errors before proceeding with the CLR.

Once the selected resource manager verifies the CLR form, contracts computer 28 computes the dollar amount of the contract labor request, based in part on the estimated regular work hours and over time hours, and submits this to resource approver 25. Resource approver 25 may determine whether to approve or disapprove the contract labor request.

Upon approval of the CLR, contracts computer 28 notifies request coordinator 23 that a new CLR form has been submitted. Request coordinator 23 may then use her computer to examine the CLR form in a GUI and allocates it to one of resource managers 24a-z. The selected one of resource managers 24a-z is then notified of the allocation and uses her computer to access the form in contracts computer 28 and display it in a GUI. Upon reviewing the form, the selected resource manager retrieves a list of available vendors, possibly a subset of vendors 40a-z, from contracts computer 28 and selects some or all of the vendors on this list for the contract labor request. Once the vendors have been identified for this contract labor request, contracts computer 28 generates a message, typically an e-mail, that is sent to each of the selected vendors, through communication network 30.

The selected ones of vendors 40a-z may then retrieve the contract labor request from contracts computer 28, through communication network 30. Upon receipt of the contract labor request, each selected vendor may determine the persons whom it believes may be able to fulfill the contract labor request. The vendors may then submit resumes of these candidates to contracts computer 28.

Upon receiving the resumes, contracts computer 28 notifies, typically by e-mail, the selected resource manager that resumes have been received. The resource manager may examine the resumes by having her computer access them in contracts computer 28 and display them in a GUI. The resource manager may determine to discard some of the resumes at this time. After this, the remaining resumes are made available to hiring manager 26. Hiring manager 26 may use her computer to access the remaining resumes in contracts computer 28 and display them in a GUI. Hiring manager 26 may determine which of the candidates that she wishes to interview. The hiring manager notifies the contracts computer 28 of the resumes that are no longer under consideration.

Hiring manager 28 may then interview the candidates. After this, the hiring manager fills out an evaluation form, which may include, for example, the date, the time, the location, the interview mode, and any comments, on each of the candidates and submits the evaluation forms to contracts computer 28. Furthermore, the hiring manager typically selects one of the candidates to fulfill the CLR.

Upon the selection of a candidate, the selected resource manager performs the final negotiation for the services of the candidate, such as for the actual billing rate, and submits the final terms for approval. Once resource approver 25 approves the final terms, the resource manager may enter the hiring information, and a welcome package and a purchase order will be sent to the vendor. A purchase order may, for example, include the purchase order number, the purchase order date, the candidate's name and social security number, the vendor's name, remit to code, and address, the billing rates, the hours, the labor amount, the expense amount, the purchase order amount, the start date and the end date. This completes the contract labor request procurement process.

Another aspect of managing contract labor activities is the submission, approval, and payment of time sheets for services rendered by consultant 50. In this process, consultant 50 uses her computer to retrieve a time sheet from contracts computer 28, through communication network 30. The consultant may view the time sheet in a GUI, fill it in, and submit it to contracts computer 28. Upon receiving the time sheet, contracts computer 28 will notify hiring manager 26 of the received time sheet. The hiring manager may then access the time sheet in contracts computer 28 using her computer and view it in a GUI. Upon examining the time sheet, the hiring manager may determine whether to approve or disapprove the time sheet. If the time sheet is disapproved, the consultant is notified and is allowed to make corrections. Once the time sheet is approved, contracts computer 28 notifies the associated vendor of the approved time sheet and allows the vendor to view the time sheet. The vendor may use her computer to generate and submit an invoice, which may include the invoice number, the tax, the total amount, and any comments, to contracts computer 28, which forwards the invoice to A/P processor 27 for payment. A/P processor 27 may then make arrangements for payment of the invoice.

System 10 has a variety of useful features. For example, by centrally controlling the information for the contract labor activities, the format of the information may be readily controlled, and the information may be accessed by the various individuals and computers. Moreover, the information from one person regarding a CLR may be readily associated with that from other persons regarding the same CLR. Additionally, because most, if not all, of the information is maintained and transferred electronically, the information is readily available to the various individuals. Thus, they may be readily updated as to the status of a CLR. Furthermore, the data may be readily manipulated to generate reports and statistics. A variety of other features exist.

In other embodiments, system 10 may have a variety of additional features. For example, the system may allow any of requesting manager 22, request coordinator 23, resource managers 24a-z, resource approver 25, and/or hiring manager 26 to view the status of contract labor requests for which they are responsible. In a particular embodiment, requesting manager 22 may determine whether a contract labor request that she has submitted has been assigned to a resource manager, approved, submitted to vendors 40a-z, and/or filled. As another example, resource manager 24 may view all of the contract labor requests for which she is responsible and determine their status, such as open, pending, or closed. Additionally, vendors 40a-z may review the contract labor requests that are currently available and contract labor requests on which they have consultants working. As a further example, consultants may use system 10 to submit other types of compensation requests, such expense reports for travel, to organization 20 for reimbursement. As a further example, a corporate administrative system (CAS), which may, for example, be a legacy system, may be included. The CAS would manage budgetary information for the contract labor requests and may be responsible for determining who the appropriate resource approver is based on the requesting manager and amount of the request. As an additional example, contracts computer 28 may maintain a database of labor rates and/or vendors. The labor rates may be organized by experience, job skill, geographic region, and/or any other appropriate factor. This information may prove helpful in projecting how much a CLR will actually cost and in negotiating rates for contract labor. The vendors may be organized by size, consultant specialty, geographic location, and/or any other appropriate factor. This information may prove helpful in choosing the vendors to which the CLR will be sent. As still a further example, each individual may have to undergo an authentication sequence to gain access to contracts computer 28, such as by using a username and password. Thus, access to contracts computer 28 may be controlled in general, and individuals that are legitimate are only given access to the information that they require. Moreover, this allows contracts computer 28 to provide each user with individualized information. A variety of other examples exist.

The components of system 10 may have a variety of forms, structures, and/or arrangements. For example, the different persons within organization 20 may be co-located, widely disbursed, or have any other geographic proximity to each other. Additionally, communication network 30 may be the Internet, the public switched telephone network (PSTN), a frame relay network, or any other type of network that allows data communications. Moreover, communication network may be a collection of different networks. Furthermore, although the devices with which the persons in FIG. 1 communicate with each other have been described as computers, these devices could be personal computers, personal digital assistants, cellular telephones, portable computers, or any other type of device for sending and receiving data. The computers may communicate with the communication networks by any type of wireline or wireless link. A variety of other examples exist.

In other embodiments, the elements of system 10 may have a variety of different configurations. For example, requesting manager 22 and hiring manager 26 may be the same person. As another example, a person other than the hiring manger may perform some of all of the interviews, in which case the interview form probably include the name and contact information for the interviewer. As a further example, small organizations may not have numerous resource managers 24a-z and, thus, may not need resource coordinator 23. As an additional example, the computer that consultant 50 uses may be part of organization 20. As still a further example, the computers that allow the persons of organization 20 to communicate with each other may be connected to communication network 30. Thus, some or all of the persons of organization 20 may be remote from each other. A variety of other configurations exist.

Additionally, although system 10 has been discussed in the context of a web-based system that uses and e-mails to send notifications and GUI's, possibly with the help of a web browser, such as Internet Explorer 4.0 or Netscape Navigator 4.0, to present information, a variety of other manners, such as fax or mail, may be used to send information between different entities in system 10, such as the vendors 40a-z and organization 20. Furthermore, some or all of the information may be presented in plain text format, in verbal format, in hard copy format, and/or any other appropriate type of format.

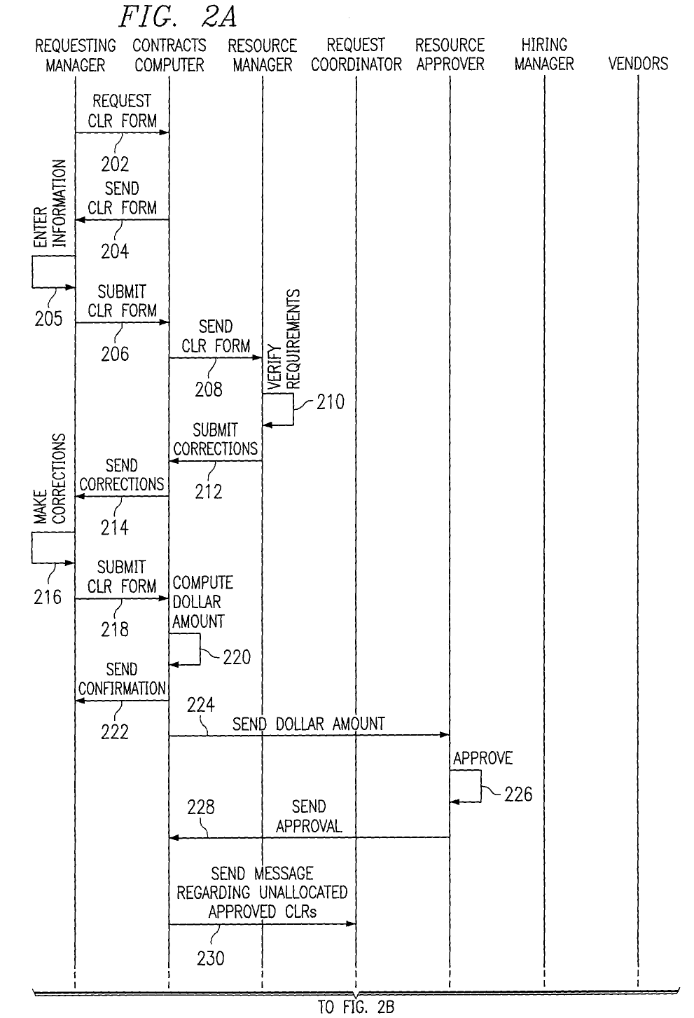

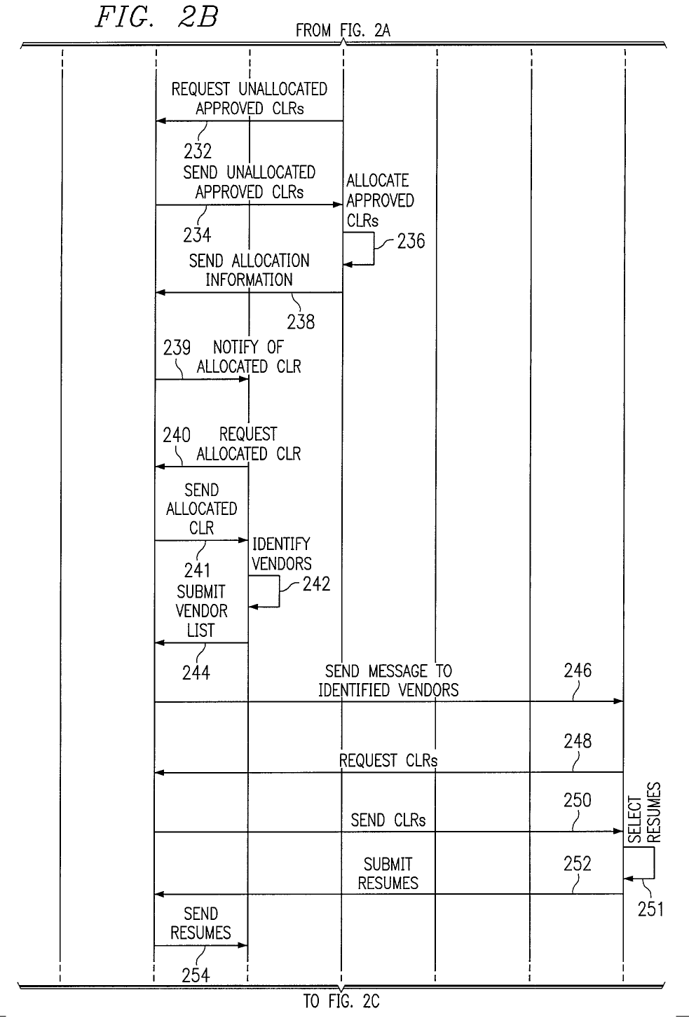

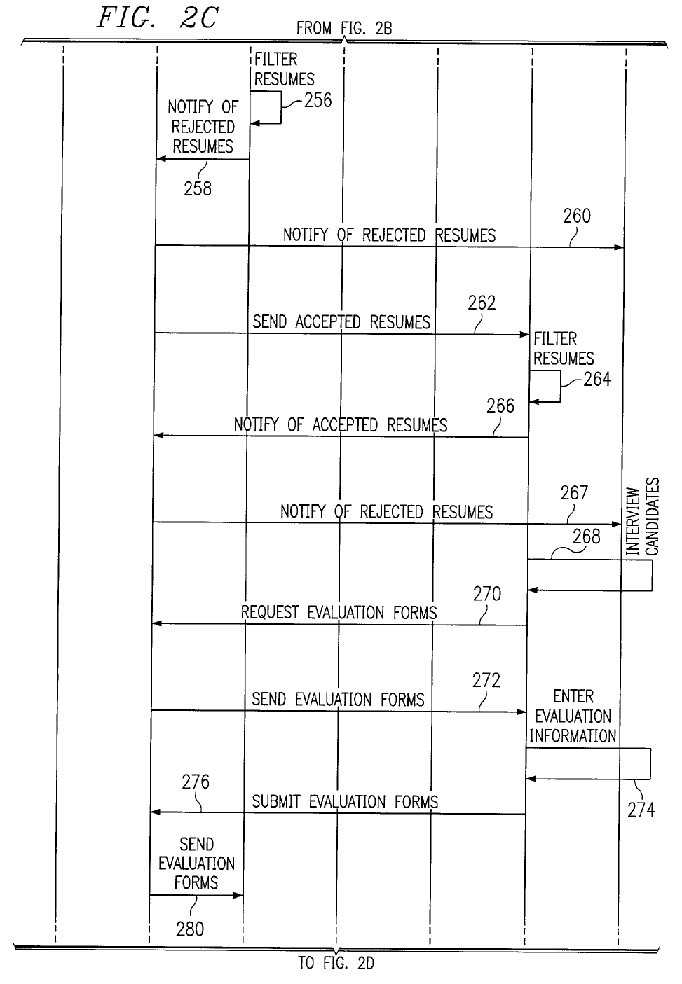

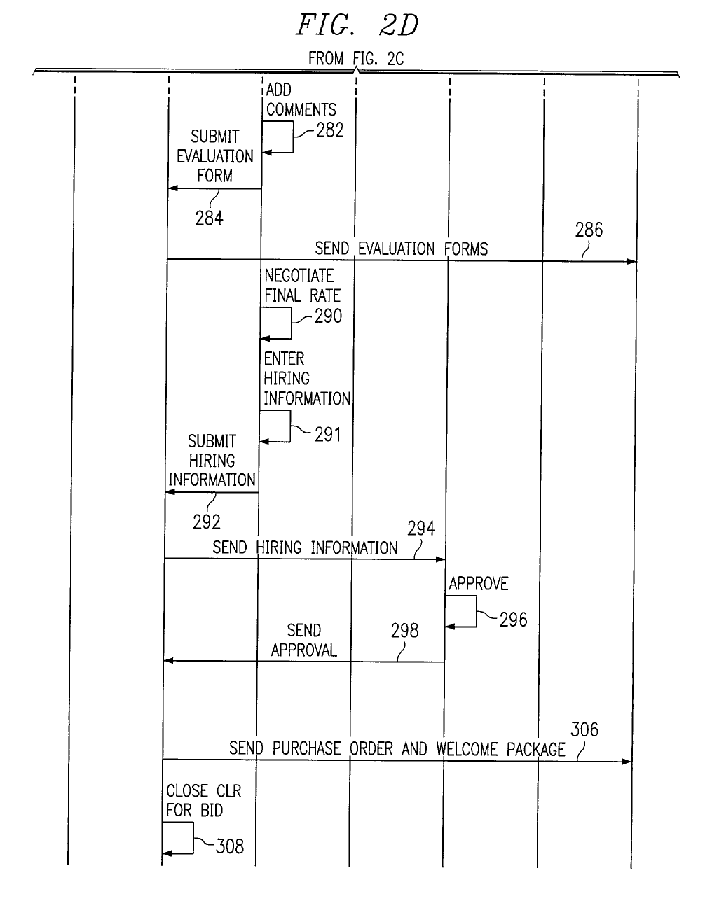

FIG. 2 shows a flow diagram for one embodiment of the operation of system 10. At step 202, the requesting manager, using her computer, requests a CLR form from the contracts computer, and at step 204, the contracts computer sends the CLR form to the requesting manager's computer. The requesting manager enters information into the CLR form at step 205 and submits the CLR form to the contracts computer at step 206. At step 208, the contracts computer sends the CLR form to one of the resource managers, who verifies the requirements in the form at step 210. If corrections are required, the resource manager submits the corrections to the contracts computer at step 212. The contracts computer then sends the corrections to the requesting manager at step 214, who makes the corrections at step 216. The requesting manager submits the CLR form again at step 218.

At step 220, the contracts computer computes the dollar amount of the CLR. Next, the contracts computer sends a confirmation to the requesting manager at step 222 and sends the dollar amount of the CLR to the resource approver at step 224. The resource approver approves the amount at step 226 and sends the approval to the contracts computer at step 228.

At step 230, the contracts computer sends a message regarding unallocated, approved CLRs to the request coordinator. The request coordinator requests the unallocated, approved CLRs from the contracts computer at step 232 and receives the unallocated, approved CLRs at step 234. The request coordinator allocates the unallocated, approved CLRs between the resources managers at step 236 and sends the allocation information to the contracts computer at step 238. The contracts computer then notifies the selected resource manager that she has been allocated a CLR at step 239. The resource manager requests the allocated CLR at step 240, and the contracts computer sends the allocated CLR to the resource manager at step 240. The resource manager then identifies potential vendors at step 242 and submits the vendor list to the contracts computer at step 244.

Upon receiving the list of identified vendors, the contracts computer, at step 246, sends them a message indicating that they may participate in the CLR, and sends the CLR to an identified vendor at step 250 upon its request at step 248. The identified vendor may then select resumes for the CLR at step 251 and submit the resumes to the contracts computer at step 252.

The contracts computer then allows the resumes to be viewed by the selected resource manager at step 254. The resource manager may then filter the resumes at step 256 and notify the contracts computer of the rejected resumes at step 258. The contracts computer then notifies the vendors of the rejected resumes at step 260 and sends the accepted resumes to the hiring manager's computer at step 262. The hiring manager's computer may present the resume information in summary fashion, such as with name, bill rate, and availability of each candidate, and/or with the full detail of each resume. The hiring manager may then filter the resumes again at step 264 and notify the contracts computer of the accepted resumes at step 266. The contracts computer then notifies the vendors of the rejected resumes at step 267. Next, the hiring manager interviews the candidates at step 268. After interviewing the candidates, the hiring manager requests evaluation forms from the contracts computer at step 270. The contracts computer sends the evaluation forms to the hiring manager at step 272. The hiring manager then enters evaluation information at step 274 and submits the evaluation forms to the contracts computer at step 276. During this step, one of the candidates is typically selected for hire. At step 280, the contracts computer sends the evaluation forms to the resource manager, who can then add her own comments at step 282 and submit the evaluation forms to the contracts computer at step 284. At step 286, the contracts computer sends the evaluation forms for each candidate to the associated vendor.

Assuming the hiring manager has selected a candidate, the resource manager negotiates the final rate for the candidate at step 290 and enters hiring information at step 291. The resource manage submits the hiring information to the contracts computer at step 292. At step 294, the contracts computer sends the hiring information to the resource approver for final approval. The resource approver approves the information at step 296 and sends the approval to the contracts computer at step 298. The contracts computer sends a purchase order, which could be created by the resource manager and/or contracts computer, and welcome package to the vendor at step 306 and closes the CLR for bid at step 308.

The process shown in FIG. 2 has several advantages. One advantage is that individuals may review the comments that others make and, thus, learn what others expect. For example, the resource manager and the vendors may review the comments of the hiring manager and, thus, learn the types of candidates in which she is interested. As another example, the requesting manager may review the comments of the resource manager and learn how to appropriately complete a CLR form. Another advantage is that the resource manager may draw upon the database for information in negotiating certain issues of the contract, such as the contract. Note that the database will be updated, and thus become more accurate, as each contract is established. A variety of other examples exist.

Although a variety of steps have been discussed with respect to FIG. 2, in other embodiments, steps may be added, deleted, and/or reordered. For example, the request coordinator may assign a resource manager to the CLR form before the resource manager verifies the information in the CLR form. As another example, the CLR may be allocated to a resource manager before or during approval by the resource approver. As a further example, the resource manager may not filter the resumes before they are sent to the hiring manager. As an additional example, the resource manager may verify the reference information before sending the selected resumes to the hiring manager. As another example, the CLR may be returned to the requesting manager with the computed cost of the project before being allocated to a resource manager. As still a further example, some or all of the notification steps may be deleted if the persons in system 10, or their computers, at least somewhat regularly poll contracts computer 28 to receive undated information regarding CLRs. As an additional example, additional notification steps may be included if individuals do not respond within a certain time period and/or if no activity occurs on a CLR within a certain time period. As another example, some information may be sent without waiting for individuals or their computers to request it from contracts computer 28, such as the CLR for the identified vendors. As a further example, some or all of the forms may be stored on the individual's computers and, thus, do not have to be requested from the contracts computer. As an additional example, steps 242-246 may be replaced by a step that sends a message regarding the CLR to all of the vendors. As another example, steps 294-298 may not be necessary if the hiring information indicates to the contract computer that the CLR will fall within preapproved guidelines from the resource approver. A variety of other examples exist.

Additionally, in other embodiments, a variety of other functions are available for system 10. For example, the requesting managers may be able to review the status, such as, for example, pending, submitted, open, on hold, cancelled, or filled, of the CLRs they have created. A CLR is pending from the time it is created until it is submitted to a resource manager. The CLR becomes open once the resource manager approves it. As another example, the hiring manager may review the same status items for the CLRs for which she is responsible. Furthermore, the hiring manager may review: 1) submitted, rejected, approved, and invoiced time sheets and expense reports; 2) open, pending, and closed purchase orders; and 3) submitted invoices. Additionally, the hiring manager may be able to use system 10 to schedule interviews for candidates and keep track of the interview schedule. The hiring manager also may be able to fill out an evaluation on each candidate as they are interviewed and decide whether to hire, reject, or keep considering the candidate. Furthermore, the hiring manager may be able to provide comments as to why she rejected the resumes, and these may be provided to the resource manager and/or vendor. As an additional example, the request coordinator and the resource manager may be able to review the status of all the CLRs for which they are responsible. Furthermore, the resource manager may be able to view and edit the list of suppliers and review the status of purchase orders, including invoices, for which she is responsible. As a further example, the vendor may use system 10 to review its profile information, review CLRs on which it is capable of proffering candidates, review the status of candidates that it has proffered, review CLRs on which it successfully proffered a candidate, review purchase orders for its services, and create and submit invoices. As still a further example, system 10 may allow consultant 50 to create time sheets and expense reports and review submitted, rejected, and approved time sheets and expense reports. As another example, the contracts computer may be able to verify the information in the CLR form and/or determine whether the CLR should receive final approval. Furthermore, the contracts computer may be able to allocate the CLR to the resource managers, identify vendors for the CLR, and/or submit the purchase order to the A/P processor. These options may be presented to the various individuals in a menu, toolbar, or other appropriate manner. Also, in certain embodiments, only part of the information in a form, such as a CLR form, a time sheet, and/or a purchase order, may be sent to a requestor. A variety of other examples exist.

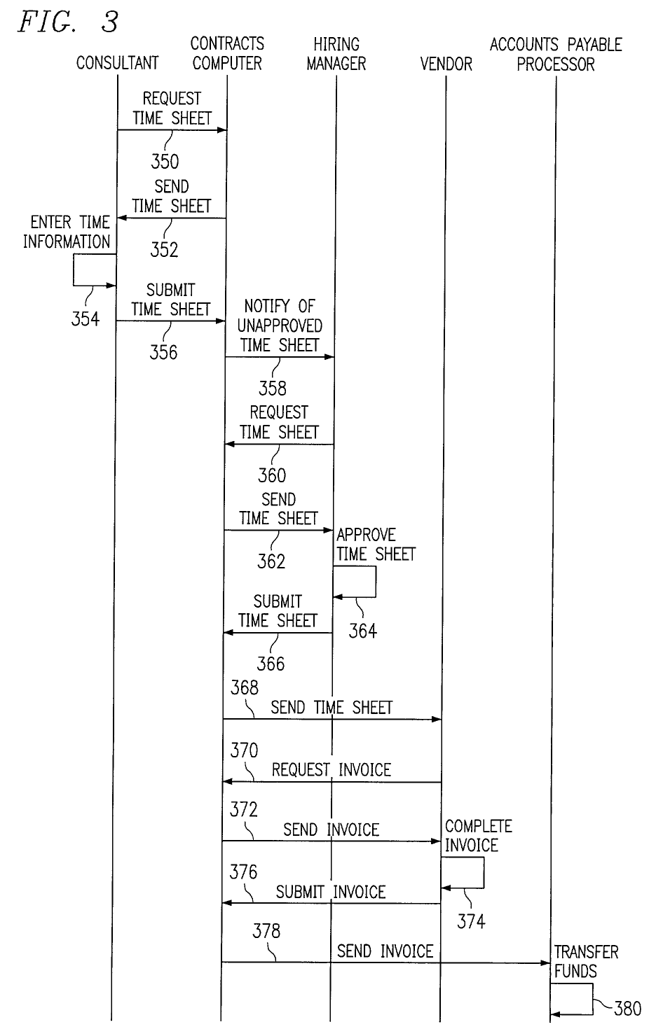

FIG. 3 illustrates a flow diagram for a contract labor billing process handled by system 10. At step 350, the consultant, using her computer, requests a time sheet from the contracts computer, which sends the time sheet to the consultant's computer at step 352. The consultant enters her time information into the time sheet displayed on her computer at step 354 and submits the time sheet to the contracts computer at step 356. The contracts computer notifies the hiring manager of an unapproved time sheet at step 358, and the hiring manager requests the time sheet in step 360. At step 362, the contracts computer sends the time sheet to the hiring manager, who may approve the time sheet at step 364. At step 366, the hiring manager submits the approved time sheet to the contracts computer, which then sends the approved time sheet to the vendor, or the accounts receivable personnel of the vendor, at step 368. The vendor requests an invoice from the contracts computer at step 370, and the contracts computer sends the invoice to the vendor's computer at step 372. At step 374, the vendor completes the invoice displayed on its computer. The vendor then submits the invoice to the contracts computer at step 376. At step 378, the contracts computer sends the invoice to the A/P processor, who makes arrangements to transfer funds to the vendor at step 380, assuming the invoice is appropriate.

Although a variety of steps have been shown with regard to the submission, approval, and payment of time sheets, in other embodiments, steps may be added, deleted, and/or reordered. For example, if the hiring manager does not approve the time sheet at step 364, the hiring manager may enter comments regarding why the time sheet was rejected and send the time sheet back to the contracts computer, which will then notify the consultant of the rejected time sheet. The consultant may then revise the time sheet and resubmit it. As a further example, the contracts computer may not need to notify the hiring manager of an unapproved time sheet if the hiring manager, or her computer, polls the contracts computer on a somewhat regular basis. As another example, the contracts computer may notify the consultant on a regular basis regarding the submission of time sheets. A variety of other examples exist.

Additionally, in other embodiments, a variety of other financial functions may be handled by system 10. For example, the consultant may be able to submit expense reports, such as for travel, in much the same way a time sheet is submitted. As a further example, the A/P processor may be able to send a message, such as an electronic funds transfer, to transfer funds to the account of the vendor and/or consultant to satisfy the invoice. As another example, the contracts computer may automatically create an invoice for the vendor so that the transfer of funds may be accelerated. A variety of other examples exist.

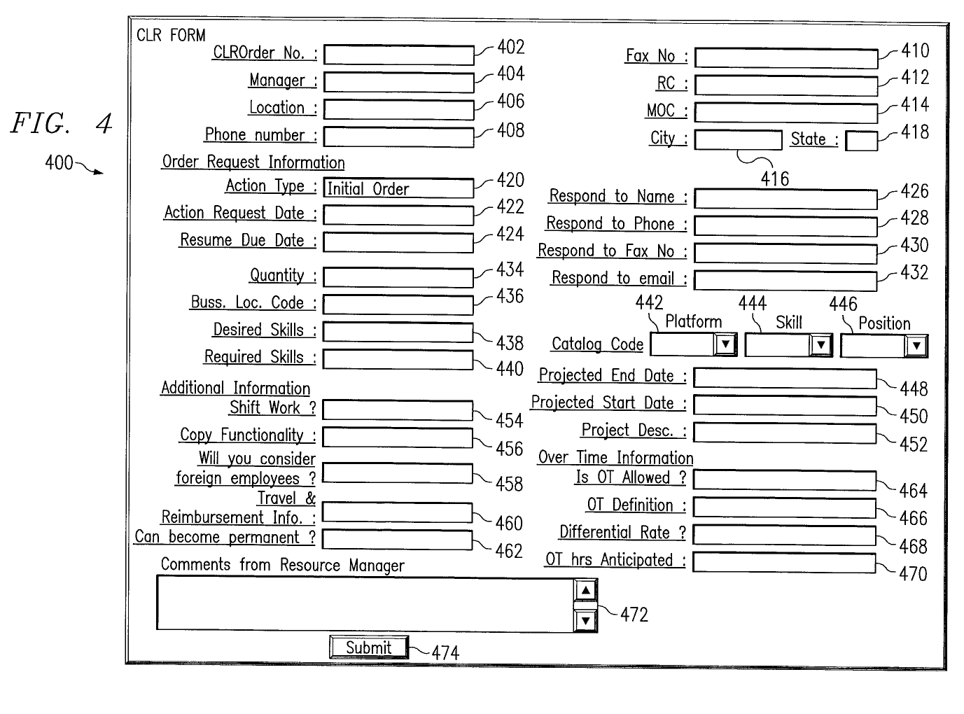

FIG. 4 illustrates a CLR form 400 that a requesting manager would fill out to initiate a CLR in system 10. As shown, CLR form 400 contains fields 402-472. The CLR order number is automatically generated by the contracts computer in field 402. Fields 404-470 need to be completed by the requesting manager. Fields 404-418 allow the entry of information regarding the requesting manager and the project for which the request is being made. For example, the requesting manager enters his name in field 404 and the account codes for the project in fields 412-414. Fields 420-432 allow entry of information regarding the application process for the CLR. For example, the requesting manager enters the date that resumes are due in field 424. Fields 434-452 allow entry of detailed information regarding the CLR. For example, field 434 allows the requesting manager to indicate how many positions are available, and field 436 allows the requesting manager to specify where the work will be performed. Furthermore, fields 438-446 allow the requesting manager to indicate the skills and experience that are required for the project. For example, for a technical CLR, field 442 allows the requesting manger to indicate what platform, such as PC, server, mainframe, on which the consultant will work, and field 444 allows the requesting manager to specify any skill, such as DB2, Oracle, or Sybase, required. In addition, fields 448 and 450 allow the requesting manager to indicate the time period for the project. Fields 454-470 allow the entry of more detailed information regarding the work. For example, field 462 allows the resource manager to indicate whether the position is one that can become permanent, and field 470 indicates whether overtime hours are anticipated.

Upon the completion of CLR form 400, the requesting manager may submit the form to the contracts computer by activating the submit button 474. As discussed previously, once the CLR form is submitted, a resource manager will review the CLR form to determine whether it has been appropriately filled out. If the form has not been appropriately filled out, the resource manager may enter comments in field 472 and send the CLR form to the contracts computer, which will send it to the requesting manager. The requesting manager may then make corrections to CLR form 400 and resubmit it.

Although FIG. 4 illustrates CLR form 400 for system 10, a variety of other forms may be useful. These forms may have more, less, and/or different arrangements of information than CLR form 400. For example, some of the information may be automatically filled in for the requesting manager, such as, for example, her name and contact information, which might be determined based on her username. Additionally, different forms may be required for different types of contract laborers, such as, for example, professional, technical, and/or clerical. As another example, other forms may include the department or organization of the requesting manager, comments from the requesting manager, a title for the project, an address for the project, the tax status of the project, the experience desired for the project, the anticipated hours for the project, and the anticipated expenses for the project. As a further example, the form may be used only to submit initial orders for a CLR and, thus, not require field 420, may not request required skills and, thus, not require field 440, and/or may not require detailed over time information. A variety of other examples exist.

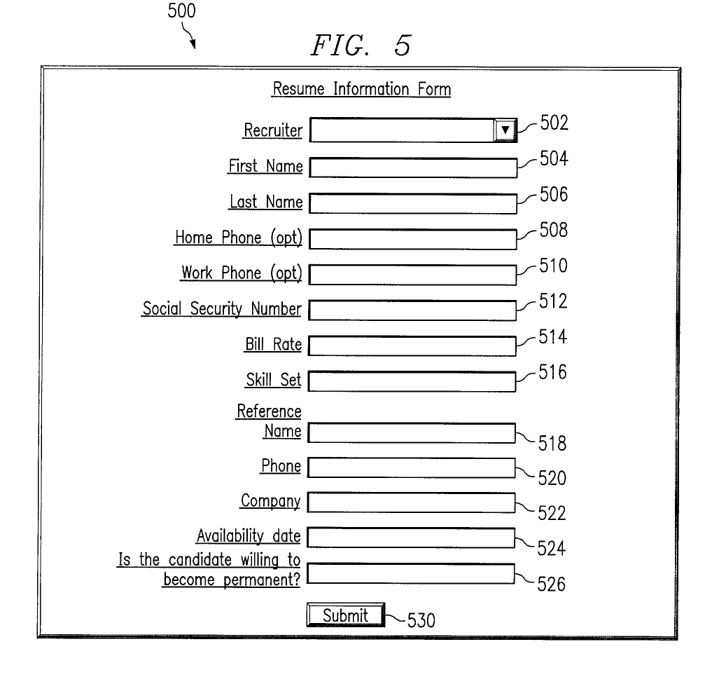

FIG. 5 illustrates a resume information form 500 that vendors 40a-z would fill out for a candidate. Resume information form 500 includes fields 502-526 that need to be completed by the vendor. In field 502, the recruiter who is completing the form for the vendor would enter their name. In fields 504-516, the recruiter enters identification information regarding the candidate. For example, the recruiter would enter the billing rate for the candidate in field 514 and the skills the candidate possesses in field 516. In fields 518-522, the recruiter would enter reference information for the candidate. Field 524 allows the recruiter to enter the availability date of the candidate, and field 526 allows the recruiter to indicate whether the candidate is willing to become a permanent employee. Upon completing resume information form 500, the recruiter may submit the form to the contracts computer by activating button 530.

In other embodiments, more, less, and/or different arrangements of information may be supplied on resume information form 500. For example, resume information form 500 may call for multiple references and/or an e-mail address for the candidate. As another example, resume information form 500 may not require the phone numbers for the candidate. As a further example, resume information form 500 may require educational background of the candidate. As an additional example, a traditional resume may be sent along with or in place of resume information form 500. A variety of other examples exist.

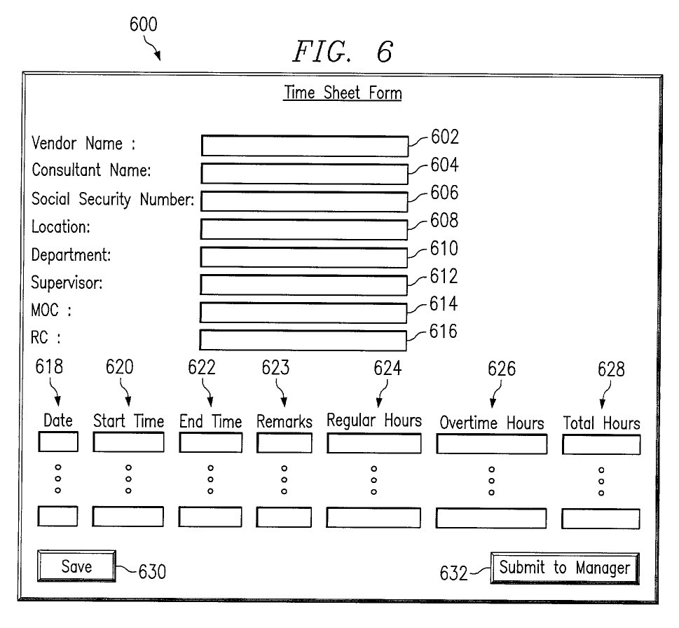

FIG. 6 illustrates a time sheet form 600 that a consultant may complete to be compensated for her time. As shown, time sheet from 600 includes fields 602-628. Fields 602-616 contain information regarding the consultant and the project on which she is working. For example, field 612 will contain the name of the consultant's supervisor in organization 20, and fields 614-616 will contain account codes for the project. In fields 618-628, the consultant enters the days and times that she worked, making any remarks in field 623. Once the consultant has completed time sheet form 600, she may submit it for payment by activating button 632.

As discussed previously, once the consultant has submitted time sheet form 600, it will be relayed to the hiring manager for the consultant by the contracts computer. The hiring manager may then review the time sheet form and determine whether it has been completed appropriately. If the time sheet form is unsuitable, the hiring manager may notify the contracts computer that the time sheet is disapproved. The contracts computer would notify the consultant that the time sheet requires correction. The consultant would then be able to retrieve time sheet form 600 and make any appropriate corrections.

In other embodiments, time sheet form 600 may include fewer, greater, and/or different arrangement of fields. For example, time sheet form 600 may contain a field indicating the status of the time sheet form, such as new, saved, submitted, rejected, or approved, a field indicating which time sheet this is for the consultant, and/or a field indicating the purchase order number. As a further example, the time sheet form may not possess the location and department fields. Moreover, some of the fields in time sheet form 600 may be automatically filled in for the consultant. For example, information such as the vendor name, the consultant name, the social security number, the location, the department, and the supervisor may be automatically filled in for the consultant when the time sheet form is retrieved from the contracts computer. A variety of other examples exist.

FIG. 7 illustrates one embodiment of contracts computer 28 for system 10. As shown, contracts computer 28 includes a communication interface 92, a memory 94, and a processor 98. Communication interface 92 is adapted to be coupled to a communication network and is capable of receiving information from and sending information to the communication network. Coupled to communication interface 92 is memory 94. Memory 94 includes software 96, which contains instructions for processor 98, and a database 97. Database 97 contains the forms, such as, for example, CLR form 400, resume information form 500, and time sheet form 600, for operating system 10. Additionally, database 97 includes all of the completed forms that have been submitted by each of the persons in system 10. Coupled to memory 94 is processor 98. Processor 98 is able to respond to the requests from the various persons using system 10 and to forward the correct forms, messages, notifications, and/or information to the various persons using system 10.

The components of contracts computer 28 may have a variety of different configurations. For example, communication interface 92 may be an Ethernet card, a modem, a transceiver, any other type of device that allows information to be exchanged with a communication network. Memory 94 may be random access memory (RAM), rewritable compact disk memory (CD-RW), a hard drive, or any other type of electromagnetic or optical volatile or not volatile device for storing information. Database 97 may be relational, flat, hierarchical, or have any other useful structure. Processor 98 may be a complex instruction set computer (CISC), a reduced instruction set computer (RISC), a biological computer, an atomic computer, or any other type of device for manipulating information.

In particular embodiments, database 97 also contains information, such as, for example, billing rates, regarding previous contract labor requests and/or information regarding vendors, such as size, labor specialty, and geographic location. This information may be useful in negotiating billing rates and selecting vendors, for example. Additionally, in certain embodiments, software 96 and database 97 may be implemented according to the Distributed Internet Architecture by Microsoft to perform contract labor activities. Furthermore, software 96 may include any of a variety of commercially available software packages for facilitating the functions of system 10, such as, for example, Microsoft Windows NT Server 4.0 (operating system), Microsoft Internet Information Server 4.0, Microsoft SQL Server 7.0 (database), Active Server Pages (HTML page implementation), Microsoft Transaction Server 2.0, VBScript, Microsoft SMTP Service (e-mail), Microsoft Excel (time sheet and invoice generation), Microsoft Word (purchase order generation), SA File Up (resume upload), JavaScript (validations), Site Server 3.0 (authentication), Secure Sockets Layer (encryption of authentication information and other information), an X500 directory (housing information about requesting mangers, hiring mangers, request coordinators, resource managers, and resource approvers), and EDI Asset (invoice handling). Additionally, in certain embodiments, the functions of contracts computer 28 may be distributed between several computers, such as, for example, an internal computer to serve the organization side personnel, an external computer to serve the vendor side personnel and the consultants, a component computer to perform the business functions, a membership computer to authenticate vendor personnel and consultants, and a database computer to house the information.

Although several embodiments of the present invention have been discussed, numerous additions, deletions, substitutions, and/or alterations to the invention may be readily suggested to one of skill in the art without departing from the scope of the appended claims. It is intended therefore that the appended claims encompass such additions, deletions, substitutions, and/or alterations.

What is claimed is:

1. A system for managing contract labor activities, comprising:
a communication interface adapted to be coupled to a communication network, the communication interface operable to receive information from and send information to the communication network;
a memory coupled to the communication interface, the memory operable to store information received through the communication interface; and
a processor coupled to the memory, the processor operable to receive a contract labor request, receive a list of vendors associated with the contract labor request, associate the list with the contract labor request, and generate a message containing information in the contract labor request for at least one of the vendors.

2. The system of claim 1, wherein the contract labor request includes an indication of the skills applicable to the requested labor and an indication of the size of the project.

3. The system of claim 1, wherein the processor is further operable to determine an estimate of the cost for the contract labor request, generate a message requesting approval of the contract labor request, and receive approval.

4. The system of claim 3, wherein determining an estimate of the cost for the contract labor request comprises determining a labor rate based on data regarding similar labor in the geographic region where the labor is to be performed.

5. The system of claim 1, wherein receiving a contract labor request includes comparing the anticipated amount of hours to be worked against the period of employment to determine whether overtime is required.

6. The system of claim 1, wherein the processor is further operable to:
receive resume information regarding candidates from at least one of the associated vendors; and
generate a message containing at least part of the resume information.

7. The system of claim 6, wherein the processor is further operable to:
receive verification that some of the resumes have been rejected; and
generate a message identifying the rejected resumes.

8. The system of claim 1, wherein the processor is further operable to:
receive information indicating that a candidate has been selected for hire; and
generate a message containing a purchase order for the services of the selected candidate.

9. The system of claim 1, wherein the processor is further operable to:
receive a compensation request;
generate a message containing information from the compensation request;
receive a message indicating that the compensation request is approved; and
generate a second message containing information from the compensation request.

10. The system of claim 1, wherein the processor is further operable to:
receive an invoice;
associate the invoice with a purchase order;
determine whether the invoice is associated with an approved compensation request; and
generate a message regarding payment of the invoice if it is associated with an approved compensation request.

11. A method for managing contract labor activities, comprising:
receiving a contract labor request through a communication interface;
receiving a list of vendors associated with the contract labor request through the communication interface;
associating the list with the contract labor request; and
generating a message containing information in the contract labor request for at least one of the vendors.

12. The method of claim 11, wherein the contract labor request includes an indication of the skills applicable to the requested labor and an indication of the size of the project.

13. The method of claim 11, further comprising:
determining an estimate of the cost for the contract labor request;
generating a message requesting approval of the contract labor request; and
receiving approval.

14. The method of claim 13, wherein determining an estimate of the cost for the contract labor request comprises determining a labor rate based on data regarding similar labor in the geographic region where the labor is to be performed.

15. The method of claim 11, wherein receiving a contract labor request includes comparing the anticipated amount of hours to be worked against the period of employment to determine whether overtime is required.

16. The method of claim 11, further comprising:
receiving resume information regarding candidates from at least one of the associated vendors; and
generating a message containing at least part of the resume information.

17. The method of claim 16, further comprising:
receiving verification that some of the resumes have been rejected; and
generating a message identifying the rejected resumes.

18. The method of claim 11, further comprising:
receiving information indicating that a candidate has been selected for hire; and
generating a message containing a purchase order for the services of the selected candidate.

19. The method of claim 11, further comprising:
receiving a compensation request;
generating a message containing information from the compensation request;
receiving a message indicating that the compensation request is approved; and
generating a second message containing information from the compensation request.

20. The method of claim 11, further comprising:
receiving an invoice;
associating the invoice with a purchase order;
determining whether the invoice is associated with an approved compensation request; and
generating a message regarding payment of the invoice if it is associated with an approved compensation request.

21. A set of logic encoded in a computer readable readable medium, the set of logic operable to:
receive a contract labor request;
receive a list of vendors associated with the contract labor request;
associate the list with the contract labor request;
generate a message for the associated vendors regarding the contract labor request;
receive an inquiry regarding the contract labor request from one of the vendors; and
generate a message containing information in the contract labor request.

22. The logic of claim 21, wherein the contract labor request includes an indication of the skills applicable to the requested labor and an indication of the size of the project.

23. The logic of claim 21, wherein the logic is further operable to:
determine an estimate of the cost for the contract labor request;
generate a message requesting approval of the contract labor request; and
receive approval.

24. The logic of claim 23, wherein determining an estimate of the cost for the contract labor request comprises determining a labor rate based on data regarding similar labor in the geographic region where the labor is to be performed.

25. The logic of claim 21, wherein receiving a contract labor request includes comparing the anticipated amount of hours to be worked against the period of employment to determine whether overtime is required.

26. The logic of claim 21, wherein the logic is further operable to:
receive resume information regarding candidates from at least one of the associated vendors; and
generate a message containing at least part of the resume information.

27. The logic of claim 26, wherein the logic is further operable to:
receive verification that some of the resumes have been rejected; and
generate a message identifying the rejected resumes.

28. The logic of claim 21, wherein the logic is further operable to:
receive information indicating that a candidate has been selected for hire; and
generate a message containing a purchase order for the services of the selected candidate.

29. The logic of claim 21, wherein the logic is further operable to:
receive a compensation request;
generate a message containing information from the compensation request;
receive a message indicating that the compensation request is approved; and
generate a second message containing information from the compensation request.

30. The logic of claim 21, wherein the logic is further operable to:
receive an invoice;
associate the invoice with a purchase order;
determine whether the invoice is associated with an approved compensation request; and
generate a message containing regarding payment of the invoice if it is associated with an approved compensation request.

31. A system for managing contract labor activities, comprising:
a communication interface adapted to be coupled to a communication network, the communication interface operable to receive information from and send information to the communication network;
a memory coupled to the communication interface, the memory operable to store information received through the communication interface, the memory further operable to store purchase orders for contract labor requests; and
a processor coupled to the memory, the processor operable to receive a compensation request, associate the compensation request with a purchase order, generate a message containing information from the compensation request, receive a message indicating that the compensation request is approved, and generate a second message containing information from the compensation request.

32. The system of claim 31, wherein the compensation request is a time sheet.

33. The system of claim 31, wherein the processor is further operable to receive an invoice associated with the compensation request, associate the invoice with the purchase order, determine whether the invoice is associated with an approved compensation request, and generate a message regarding payment of the invoice if it is associated with an approved compensation request.

34. The system of claim 31, wherein the processor is further operable to receive a contract labor request and to determine an estimate of the cost for the contract labor request.

35. The system of claim 34, wherein determining an estimate of the cost for the contract labor request comprises determining a labor rate based on data regarding similar labor in the geographic region where the labor is to be performed.

36. The system of claim 34, wherein the processor is further operable to receive a list of vendors associated with the contract labor request, generate a message for the associated vendors regarding the contract labor request, receive an inquiry regarding the contract labor request from one of the vendors, and generate a message containing information in the contract labor request.

37. The system of claim 34, wherein the processor is further operable to:
receive resume information regarding candidates from at least one of the associated vendors;
generate a message containing at least part of the resume information;
receive verification that some of the resumes have been rejected; and
generate a message identifying the rejected resumes.

38. The system of claim 34, wherein the processor is further operable to:
receive information indicating that a candidate has been selected for hire; and
generate a message containing a purchase order for the services of the candidate.

39. A method for managing contract labor activities, comprising:
storing purchase orders for contract labor requests in a memory;
receiving a compensation request through a communication interface;
associating the compensation request with a purchase order;
generating a message containing information from the compensation request;
receiving a message indicating that the compensation request is approved; and
generating a second message containing information from the compensation request.

40. The method of claim 39, wherein the compensation request is a time sheet.

41. The method of claim 39, further comprising:
receiving an invoice associated with the compensation request;
associating the invoice with the purchase order;
determining whether the invoice is associated with an approved compensation request; and
generating a message regarding payment of the invoice if it is associated with an approved compensation request.

42. The method of claim 39, further comprising:
receiving a contract labor request; and
determining an estimate of the cost for the contract labor request.

43. The method of claim 42, wherein determining an estimate of the cost for the contract labor request comprises determining a labor rate based on data regarding similar labor in the geographic region where the labor is to be performed.

44. The method of claim 42, further comprising:
receiving a list of vendors associated with the contract labor request;
generating a message for the associated vendors regarding the contract labor request;
receiving an inquiry regarding the contract labor request from one of the vendors; and
generating a message containing information in the contract labor request.

45. The method of claim 42, further comprising:
receiving resume information regarding candidates from at least one of the associated vendors;
generating a message containing at least part of the resume information;
receiving verification that some of the resumes have been rejected; and
generating a message identifying the rejected resumes.

46. The method of claim 42, further comprising:
receiving information indicating that a candidate has been selected for hire; and
generating a message containing a purchase order for the services of the candidate.

47. A set of logic encoded in a computer readable medium, the logic operable to:
receive a compensation request;
associate the compensation request with a purchase order;
generate a message containing information from the compensation request;
receive a message indicating that the compensation request is approved; and
generate a second message containing information from the compensation request.

48. The logic of claim 47, wherein the compensation request is a time sheet.

49. The logic of claim 47, wherein the logic is further operable to:
receive an invoice associated with the compensation request;
associate the invoice with the purchase order;
determine whether the invoice is associated with an approved compensation request; and
generate a message regarding payment of the invoice if it is associated with an approved compensation request.

50. The logic of claim 47, wherein the logic is further operable to:
receive a contract labor request; and
determine an estimate of the cost for the contract labor request.

51. The logic of claim 50, wherein determining an estimate of the cost for the contract labor request comprises determining a labor rate based on data regarding similar labor in the geographic region where the labor is to be performed.

52. The logic of claim 50, wherein the logic is further operable to:
receive a list of vendors associated with the contract labor request;
generate a message for the associated vendors regarding the contract labor request;
receive an inquiry regarding the contract labor request from one of the vendors; and
generate a message containing information in the contract labor request.

53. The logic of claim 50, wherein the logic is further operable to:
receive resume information regarding candidates from at least one of the associated vendors;
generate a message containing at least part of the resume information;
receive verification that some of the resumes have been rejected; and
generate a message identifying the rejected resumes.

54. The logic of claim 50, wherein the logic is further operable to:
receive information indicating that a candidate has been selected for hire; and
generate a message containing a purchase order for the services of the candidate.

55. A system for managing contract labor activities, comprising:
a communication interface adapted to be coupled to a communication network, the communication interface operable to receive information from and send information to the communication network;
a memory coupled to the communication interface, the memory operable to store information received through the communication interface, the memory further operable to store purchase orders for contract labor requests; and
a processor coupled to the memory, the processor operable to receive a contract labor request, receive a list of vendors associated with the contract labor request, associate the list with the contract labor request, generate a message for the associated vendors regarding the contract labor request, receive an inquiry regarding the contract labor request from one of the vendors, generate a message containing information in the contract labor request, receive information indicating that a candidate has been selected for hire, generate a message containing a purchase order for the services of the selected candidate, receive a compensation request associated with the purchase order, associate the compensation request with the purchase order, generate a message containing information from the compensation request, receive a message indicating that the compensation request is approved, and generate a second message containing information from the compensation request.

56. A method for managing contract labor activities, comprising:
storing purchase orders for contract labor requests;
receiving a contract labor request;
receiving a list of vendors associated with the contract labor request;
associating the list with the contract labor request;
generating a message for the associated vendors regarding the contract labor request;
receiving an inquiry regarding the contract labor request from one of the vendors;
generating a message containing information in the contract labor request;
receiving information indicating that a candidate has been selected for hire;
generating a message containing a purchase order for the services of the selected candidate;
receiving a compensation request associated with the purchase order;
associating the compensation request with the purchase order;
generating a message containing information from the compensation request;
receiving a message indicating that the compensation request is approved; and
generating a second message containing information from the compensation request.
